(19) United States
(12) Patent Application Publication
(10) Pub. No.: US 2024/0427274 A1
(43) Pub. Date: Dec. 26, 2024

(54) IMAGE FORMING APPARATUS

(71) Applicant: SHARP KABUSHIKI KAISHA, Sakai City (JP)

(72) Inventor: Yuhji NAKAGAWA, Sakai City (JP)

(21) Appl. No.: 18/666,126

(22) Filed: May 16, 2024

(30) Foreign Application Priority Data
Jun. 22, 2023 (JP) 2023-102595

(51) Int. Cl. G03G 15/00; G03G 15/20

(52) U.S. Cl. CPC G03G 15/5045; G03G 15/2017

(57) ABSTRACT

An image forming apparatus including: an image former that performs image formation by heating and fusing toner on a recording medium with a removable and replaceable fusing unit; a fusing unit detector that detects whether the fusing unit is installed; an operation receiver that receives a command from a user; and a controller having at least one CPU, the controller controlling the image former, the fusing unit detector, and the operation receiver, wherein when the operation receiver receives a command to prepare for replacement of the fusing unit, the controller causes the fusing unit detector to detect whether the fusing unit is installed; and when the fusing unit is not installed, the controller determines that the fusing unit is ready to be replaced.

### CROSS-REFERENCE TO RELATED APPLICATION

The present application claims priority from Japanese Application JP2023-102595, the content to which is hereby incorporated by reference in to this application.

### BACKGROUND OF THE INVENTION

### Field of the Invention

The present disclosure relates to an image forming apparatus, and more specifically, to an image forming apparatus that performs image formation by heating and fusing toner on a recording medium with a removable and replaceable fusing unit.

### Description of the Background Art

In image forming apparatuses such as multifunction devices, it is known that users replace and install a dedicated fusing unit for image formation, which is specified according to a size and a type of paper.

Such user-replaceable units are generally called ORUs (Operator Replaceable Units). Since such a fusing unit heats and fuses images at high temperatures during image formation, it is very dangerous to replace the fusing unit immediately after the image formation because there is a risk of burns and the like.

Traditionally, to avoid such a danger when replacing the fusing unit, a cooling fan is used to cool down a developer, a transfer material transport path, or an electric board in a main unit during operation; and thus an image forming apparatus that can cool down the entire fusing unit at once is proposed for situations when a user must access or touch the fusing unit, for example, when jamming occurs and the user needs to clear the jamming.

Another image forming apparatus is also proposed that has a reporting unit to inform an operator of information corresponding to whether or not a fuser mounted has dropped below a predetermined temperature at a time when the fuser is replaced so that general users other than service personnel can safely carry out the fusing equipment replacement work in the image forming apparatus.

The situation in which the fusing unit is replaced is not limited to a case where the fusing unit is replaced while the power of the image forming apparatus is on.

For example, there could be a case where a fusing unit is removed from the apparatus after the power is turned off the day before, and the same or different type of fusing unit is installed before the imaging forming apparatus is turned on the next morning.

In a case like this, the temperature of the fusing unit cannot be measured while the fusing unit is removed from the apparatus, and thus it is impossible to determine at all whether or not the fusing unit has dropped to a safe temperature, resulting in a situation where the process cannot proceed.

The present disclosure has been made in view of the above circumstances, and its purpose is to provide an image forming apparatus capable of making preparations for replacement of a fusing unit more appropriately than before.

### SUMMARY OF THE INVENTION

An image forming apparatus according to the present disclosure includes: an image former that performs image formation by heating and fusing toner on a recording medium with a removable and replaceable fusing unit; a fusing unit detector that detects whether the fusing unit is installed; an operation receiver that receives a command from a user; and a controller having at least one CPU, the controller controlling the image former, the fusing unit detector, and the operation receiver, wherein when the operation receiver receives a command to prepare for replacement of the fusing unit, the controller causes the fusing unit detector to detect whether the fusing unit is installed; and when the fusing unit is not installed, the controller determines that the fusing unit is ready to be replaced.

In the present disclosure, the “image forming apparatus” is an apparatus that forms and outputs an image and includes, for example, a copier and a multifunction device having a copy function, such as a printer that uses an electrophotographic method to form the image using toner, and an MFP (multifunctional peripheral) having the copy function and other functions.

According to one aspect of the present disclosure, when a fusing unit is not installed, the controller determines that the fusing unit is ready to be replaced, thus realizing the image forming apparatus capable of making preparations for replacement of a fusing unit more appropriately than before.

### BRIEF DESCRIPTION OF THE DRAWINGS

FIG. 1 is a perspective view of the exterior of a digital multifunction device in accordance with Embodiment 1 of the present disclosure.

FIG. 2 is a block diagram showing a schematic configuration of the digital multifunction device shown in FIG. 1.

FIG. 3 is a flowchart showing an example of a replacement preparation process for a fusing unit of the digital multifunction device of FIG. 1.

FIG. 4 is an example of a “Fusing Unit Counter Display/Replacement” screen that appears on a display when replacing the fusing unit of the digital multifunction device of FIG. 1.

FIG. 5 is an example of a “Fusing Unit Replacement” screen that appears on the display when replacing the fusing unit of the digital multifunction device of FIG. 1.

FIG. 6 is an example of a message that appears on the display when replacing the fusing unit of the digital multifunction device of FIG. 1.

FIG. 7 is an example of a message that appears on the display during preparations for replacement of the fusing unit of the digital multifunction device of FIG. 1.

FIG. 8A to 8B are examples of guidance that appear on the display when replacing the fusing unit of the digital multifunction device of FIG. 1.

FIG. 9 is an example of a fusing unit selection screen that appears on the display to select a fusing unit that was installed after the replacement of the fusing unit of the digital multifunction device of FIG. 1.

FIG. 10 is an example of a screen that appears on the display and indicates the currently installed fusing unit after the replacement of the fusing unit of the digital multifunction device of FIG. 1.

### DESCRIPTION OF THE PREFERRED EMBODIMENTS

Furthermore, preferred embodiments of the present disclosure will be described.

The image forming apparatus of the present disclosure may be configured such that when the operation receiver receives the command to prepare for replacement of the fusing unit, the controller determines whether predetermined replacement preparation completion conditions of the fusing unit are met; and when the replacement preparation completion conditions are met, the controller determines that the fusing unit is ready to be replaced.

In this way, when the predetermined replacement preparation completion conditions of the fusing unit are met, the controller determines that the fusing unit is prepared for replacement, thus achieving the image forming apparatus that allows the preparations for replacement of the fusing unit more appropriately than the conventional method.

The image forming apparatus of the present disclosure may be configured such that in a case where a predetermined time has elapsed since the fusing unit was in a predetermined temperature control stopped state, the controller determines that the replacement preparation completion conditions are met.

In this way, the controller determines that the replacement preparation completion conditions are met when the predetermined time has elapsed since the fusing unit was in the temperature control stopped state, thus achieving the image forming apparatus that allows the preparations for replacement of the fusing unit more appropriately than before.

The image forming apparatus of the present disclosure may further include a fusing unit cooler that cools the fusing unit, and may be configured such that when the operation receiver receives the command to prepare for replacement of the fusing unit, the controller causes the fusing unit detector to detect whether the fusing unit is installed; and when the fusing unit is installed, and the predetermined replacement preparation completion conditions of the fusing unit are not met, the controller causes the fusing unit cooler to start cooling the fusing unit.

In this way, when the fusing unit is installed, and the replacement preparation completion conditions of the fusing unit are not met, the controller causes the fusing unit cooler to start cooling down the fusing unit, thus enabling the image forming apparatus to make the preparations for replacement of the fusing unit more appropriately than before.

The image forming apparatus of the present disclosure may further include a temperature measuring unit that measures temperature of the fusing unit, and may be configured such that after the controller causes the fusing unit cooler to start cooling the fusing unit, and when the temperature measuring unit measures that the fusing unit has cooled to a predetermined temperature, the controller determines that the fusing unit is ready to be replaced.

In this way, after the fusing unit cooler starts cooling down the fusing unit, and when the temperature measuring unit measures that the fusing unit has cooled to the predetermined temperature, the controller determines that the fusing unit is ready for replacement, thus enabling the image forming apparatus to make the preparations for replacement of the fusing unit more appropriately than the conventional method.

The present disclosure will be described below in more detail with reference to the accompanying drawings. The following description is illustrative in all respects and should not be construed as limiting the present disclosure.

### EMBODIMENT 1

### Configuration of Digital Multifunction Device 1

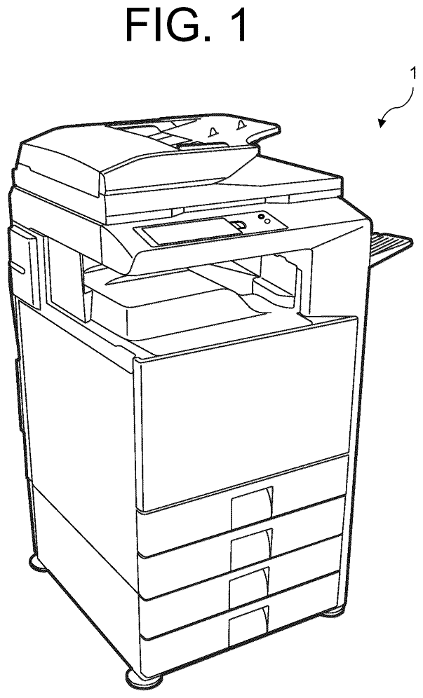

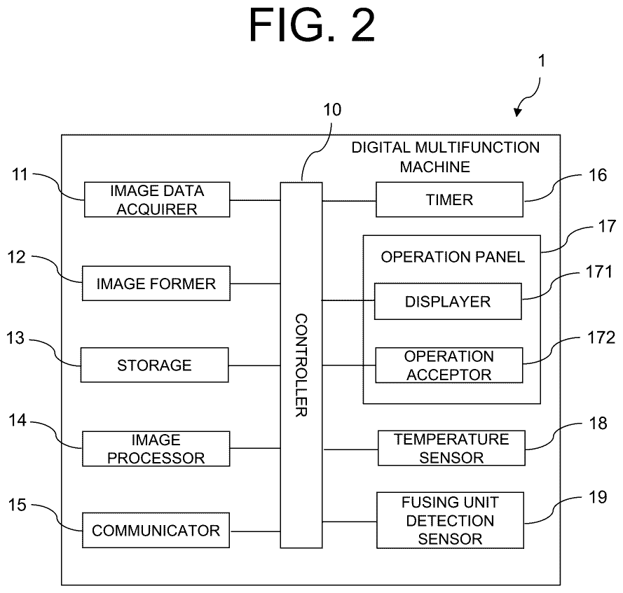

A digital multifunction device 1 according to an embodiment of an image forming apparatus of the present disclosure will be described with reference to FIG. 1 and FIG. 2.

FIG. 1 shows a perspective view of the exterior of the digital multifunction device 1 of the present disclosure.

FIG. 2 shows a block diagram of a schematic configuration of the digital multifunction device of FIG. 1.

The digital multifunction device 1 is a device such as an MFP that digitally processes image data and has a copy function, a printer function, a scanner function, a facsimile function, and an e-mail transmission function.

As shown in FIG. 2, the digital multifunction device 1 includes: a controller 10; an image data acquirer 11; an image former 12; a storage 13; an image processor 14; a communicator 15; a timer 16; an operation panel 17; a temperature sensor 18; and a fusing unit detection sensor 19.

The digital multifunction device 1 may include one or more controllers 10.

Each component of the digital multifunction device 1 will be described below.

The controller 10 is to integrally control the digital multifunction device 1, and includes at least one CPU (Central Processing Unit), at least one RAM (Random Access Memory), at least one ROM (Read Only Memory), various interface circuits, and so forth.

In order to control the operation of the entire digital multifunction device 1, the controller 10 monitors and controls detection by sensors, and all loads such as a motor, a clutch, and the operation panel 17.

The image data acquirer 11 is to detect and read a document placed on a document table or a document transported from a document tray and to generate image data.

The image data acquirer 11 may acquire image data from an external information processing device or the like via a wired or wireless network (not shown in the drawings) or may acquire image data recorded in a USB or the like, or may acquire image data by combining these methods.

The image former 12 is to print out, on paper, the image data acquired by the image data acquirer 11 and processed by the image processor 14.

The image former 12 comprises a fusing unit that heats and fuses toner on a recording medium, and the fusing unit is provided in the apparatus in a removable and replaceable manner.

The storage 13 is an element or a storage medium that stores information, which is required to implement various functions of the digital multifunction device 1, a control program, and the like. The storage 13 may be, for example, at least one semiconductor device such as at least one RAM or at least one ROM, or at least one storage medium such as at least one hard disk, at least one flash storage, or at least one SSD (Solid State Drive).

The storage 13 stores information and data required to perform a job, for example, information on a job, such as printing, and image data.

A program and data may be held in different devices, such that the data is held in a hard disk drive and the program is held in a flash storage.

The image processor 14 is to convert image data input from the image data acquirer 11 into an appropriate electrical signal and to perform process so that the image data become suitable for output with enlargement, reduction, or the like, based on a command to perform a job, such as printing, that is input from an operation receiver 172.

The communicator 15 is to communicate with external devices, such as an external personal computer (PC), a portable information terminal, and an information processing device, via wired/wireless networks.

The timer 16 is to measure and count time, and acquires the time through, for example, a built-in clock or the wired/wireless networks.

The timer 16 is used, for example, to measure time it takes for the fusing unit to cool to a predetermined temperature.

The operation panel 17 includes: a display panel that includes a liquid crystal panel or the like; and a touch panel or touchscreen that overlaps with the display panel and uses a capacitive method or the like to detect a position of a finger touch. The operation panel 17 includes a display 171 and the operation receiver 172.

The display 171 is to display various types of information.

The display 171 is composed of, for example, a CRT display, a liquid crystal display, an EL display, or the like, and is a display device such as a monitor or a line display for an operating system or application software to display electronic data in a processing state or the like.

The controller 10 displays the operation and state of the digital multifunction device 1 using the display 171.

The operation receiver 172 is an interface used to operate the digital multifunction device 1, and is to receive a command from a user.

The temperature sensor 18 is to measure temperature of the fusing unit of the multifunction digital device 1.

The temperature sensor 18 is mounted, for example, near a surface of a fusing belt, which is not shown in the drawings, and measures temperature of the fusing belt.

The fusing unit detection sensor 19 is to detect whether or not a fusing unit is installed. If the temperature sensor 18 is capable of detecting that a fusing unit is unconnected (Hi-Z) and determining that the fusing unit is in a state of non-installation (has not been installed), there is no need to provide the fusing unit detection sensor 19 in addition to the temperature sensor 18.

### Replacement Preparation Process for Fusing Unit of Digital Multifunction Device according to Embodiment 1 of the Present Disclosure

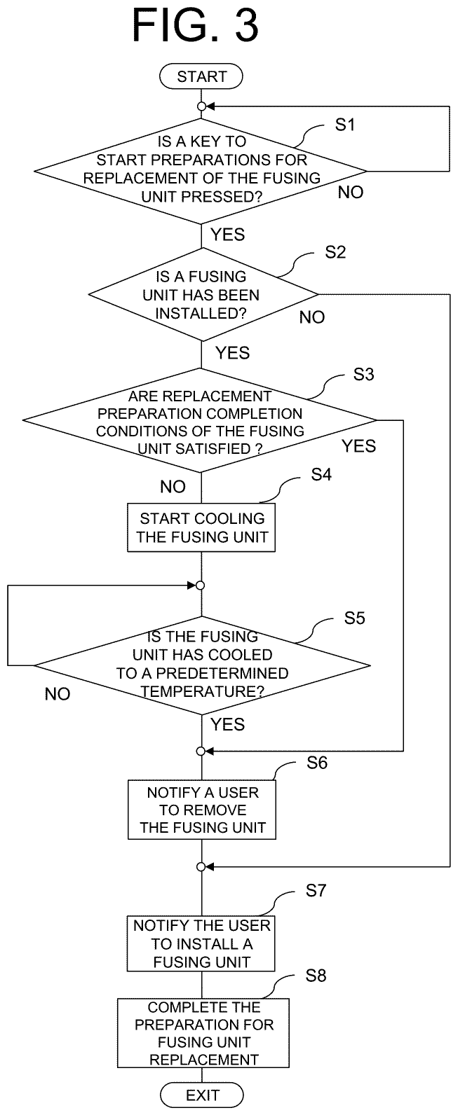

With reference to FIG. 3, a replacement preparation process for a fusing unit of the digital multifunction device 1 will be described below according to Embodiment 1 of the present disclosure.

FIG. 3 shows a flowchart showing an example of the replacement preparation process for the fusing unit of the digital multifunction device 1 shown in FIG. 1.

In step S1 shown in FIG. 3, the controller 10 of the digital multifunction device 1 determines whether or not a key to start prepare for replacement of the fusing unit displayed on the display 171 is pressed or touched (step S1).

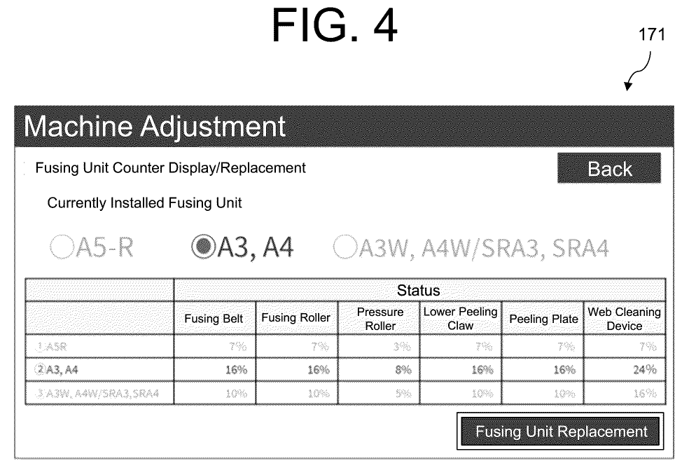

When the key to start the preparations for replacement of the fusing unit displayed on the display 171 is pressed (when the answer in step S1 is determined to be Yes), the controller 10 causes the display 171 to display a screen shown in FIG. 4; and when a “Fusing Unit Replacement” key is pressed, the screen moves to step S2. In step S2, the controller 10 determines whether or not the fusing unit detection sensor 19 has detected the installation of a fusing unit (step S2).

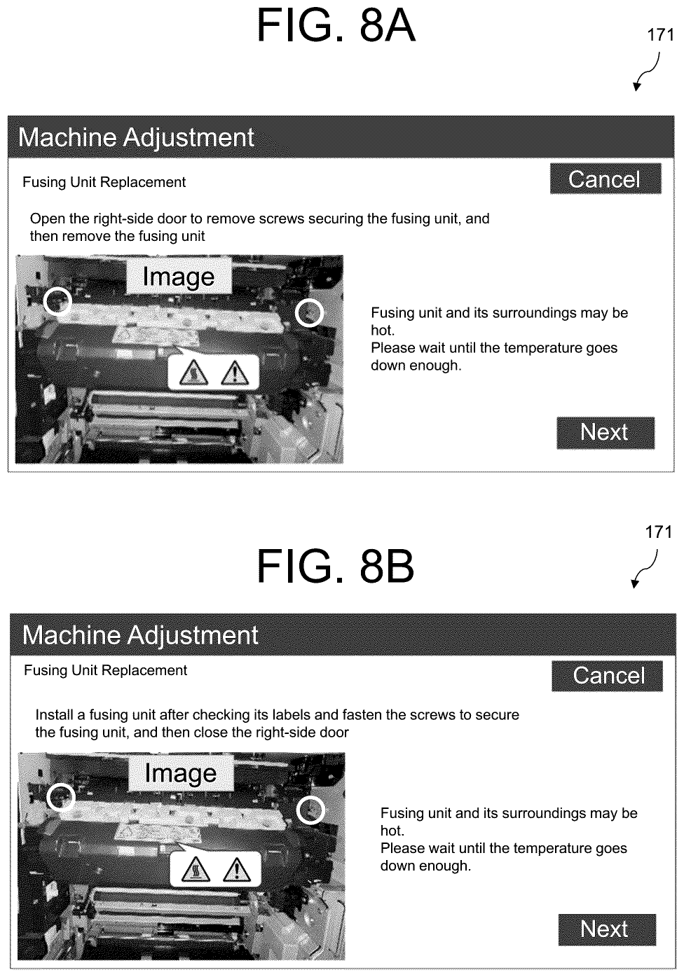

When the fusing unit detection sensor 19 does not detect the installation of the fusing unit (when the answer in step S2 is determined to be No), in step S7, the controller 10 causes the display 171 to display a screen as shown in FIG. 8B to notify a user to install a fusing unit (step S7).

As described above, when a fusing unit is not installed at a time of starting preparations for replacement of the fusing unit, the fusing unit is considered to have already cooled and can be immediately considered ready for replacement.

In the meanwhile, when the fusing unit detection sensor 19 has detected that a fusing unit is installed (when the answer in step S2 is determined to be Yes), the controller 10 determines in step S3 whether or not replacement preparation completion conditions of the fusing unit are satisfied (step S3).

When a predetermined time has elapsed since the occurrence of any of the following temperature control stopped states of the fusing unit, the replacement preparation completion conditions of the fusing unit are assumed to be satisfied.

### Temperature Control Stopped States of the Fusing Unit

The apparatus is turned off.
The apparatus is in eco-scan mode.
Jamming/error or other problems occur.
Door of the apparatus is open.

When any of these temperature control stopped states of the fusing unit occur, the heating of the fusing unit immediately stops. The controller 10 causes the timer 16 to measure time so as to determine whether or not the time has elapsed for the fusing unit to drop to a safe temperature.

When the predetermined time has elapsed since any of the temperature control stopped states of the fusing unit occurred at a time of starting preparations for replacement of the fusing unit, the fusing unit is considered to have already cooled and can be immediately considered ready for replacement.

When the replacement preparation completion conditions of the fusing unit are met (when the answer in step S3 is determined to be Yes), in step S6, the controller 10 causes the display 171 to display a screen as shown in FIG. 8A to notify the user to remove the fusing unit (step S6).

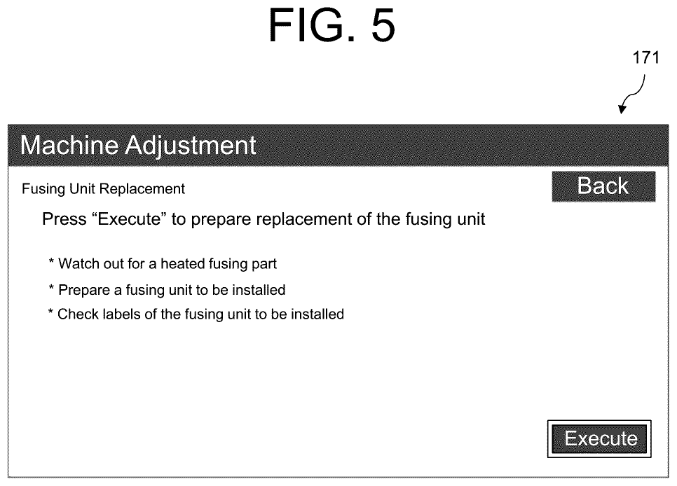

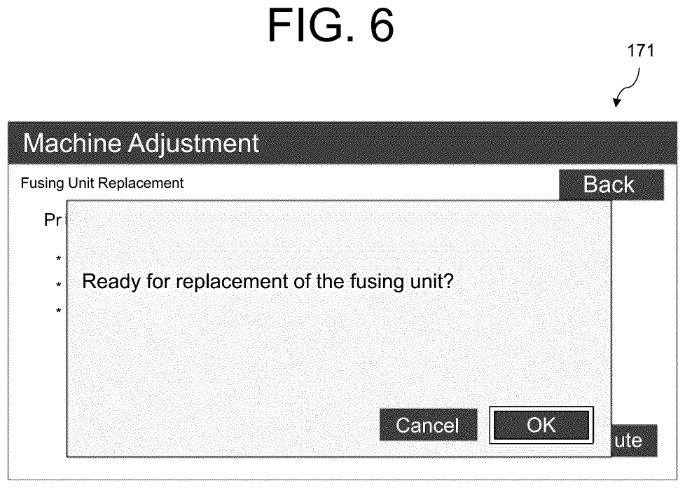

When the replacement preparation completion conditions of the fusing unit are not met (when the answer in step S3 is determined to be No), the controller 10 causes the display 171 to display a screen as shown in FIG. 5. When an “Execute” key is pressed, the controller 10 causes the display 171 to display a screen as shown in FIG. 6; and when an “OK” key is pressed, the controller 10 moves to a process in step S4.

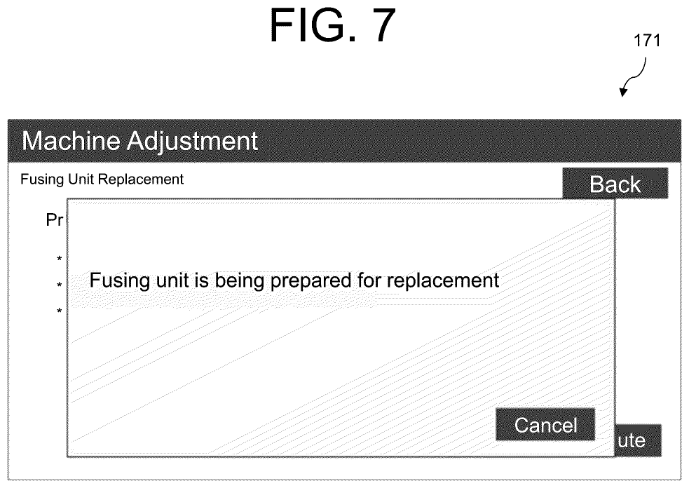

In step S4, the controller 10 causes the display 171 to display a screen as shown in FIG. 7 and drives a cooling fan (not shown) to start cooling the fusing unit (step S4).

In step S5, the controller 10 determines whether or not the fusing unit is cooled to the predetermined temperature (step S5).

When the fusing unit has cooled to the predetermined temperature (when the answer in step S5 is determined to be Yes), in step S6, the controller 10 causes the display 171 to display a screen as shown in FIG. 8A to notify the user to remove the fusing unit (step S6).

Then, by pressing a “Next” key, the controller 10 causes the screen to move to processes in steps S7 and S8.

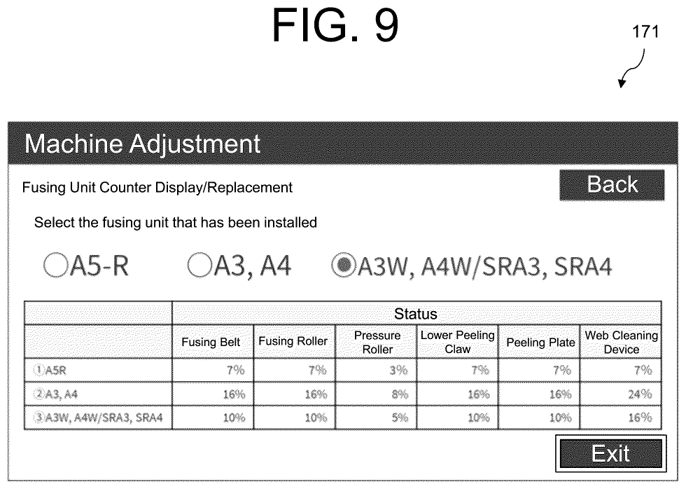

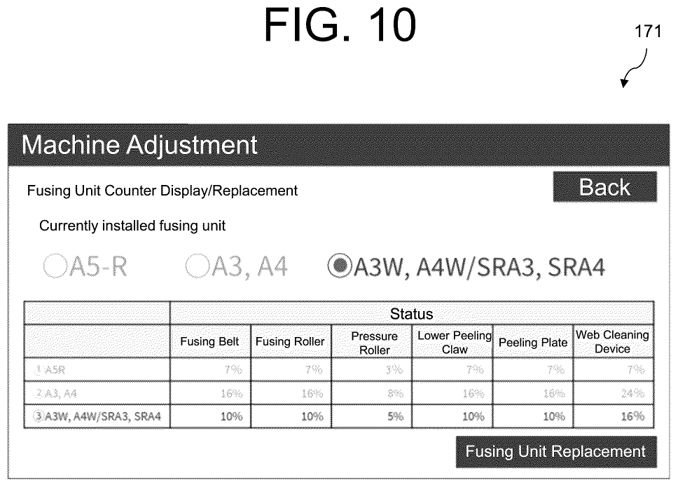

In step S8, the controller 10 detects that a setting of a different type of fusing unit after replacement has been made by a managing user (an operating user) according to procedures shown in screens in FIG. 9 and FIG. 10, completing the replacement process.

Next, the procedures for replacing a fusing unit of the digital multifunction device 1 according to Embodiment 1 of the present disclosure will be described with reference to FIG. 4 through FIG. 10.

FIG. 4 shows an example of a “Fusing Unit Counter Display/Replacement” screen displayed on the display 171 when replacing a fusing unit of the digital multifunction device 1 shown in FIG. 1.

In FIG. 4, three types of installable fusing units for different paper sizes—“A5-R”, “A3, A4”, and “A3W, A4W/SRA3, SRA4”—are indicated as examples.

When a managing user, who manages and operates the apparatus, presses a “Fusing Unit Counter Display/Replacement” key on a setting screen displayed on the display 171, a screen shown in FIG. 4 appears.

This screen shows that a fusing unit for the paper size of “A3, A4” is installed as indicating “Currently Installed Fusing Unit”.

The screen in FIG. 4 shows statuses of components of the three types of fusing units—a fusing belt, a fusing roller, a pressure roller, a lower peeling claw, a peeling plate, and a web cleaning device.

Status values (%) in the section titled “Status” indicate a current percentage of each component, such as the fusing belt, relative to its maximum life of 100%.

FIG. 4 shows an example of the fusing unit for the paper size of “A3, A4” such as 16% fusing belt, 16% fusing roller, 8% pressure roller, 16% lower peeling claw, 16% peeling plate, and 24% web cleaning device.

When the managing user presses a “Fusing Unit Replacement” key in the lower right corner of the screen in FIG. 4, a screen shown in FIG. 5 appears.

FIG. 5 shows an example of a “Fusing Unit Replacement” screen displayed on the display 171 when replacing the fusing unit of the digital multifunction device 1 shown in FIG. 1.

The screen shown in FIG. 5 displays a message “Press ‘Execute’ to prepare for replacement of the fusing unit” and cautions for replacing the fusing unit.

When the managing user presses the “Execute” key on the screen shown in FIG. 5, a final confirmation message pops up to prepare for the replacement of the fusing unit.

FIG. 6 shows an example of the message displayed on the display 171 when replacing the fusing unit of the digital multifunction device 1 of FIG. 1.

When an “OK” key in a pop-up display shown in FIG. 6 is pressed by the managing user, the controller 10 determines that a key to start preparations for replacement of the fusing unit in step S1 in FIG. 3 is pressed.

FIG. 7 shows an example of a message that appears on the display 171 while preparing to replace the fusing unit of the digital multifunction device 1 of FIG. 1.

As shown in the example in FIG. 7, the message is displayed indicating that the fusing unit is being prepared for replacement.

The controller 10 waits until the fusing unit is ready to be replaced according to a flowchart shown in FIG. 3.

FIG. 8 shows examples of guidance that appear on the display 171 when replacing the fusing unit of the digital multifunction device 1 of FIG. 1. FIG. 8A shows the example of the guidance for removing the fusing unit; and FIG. 8B shows the example of the guidance for installing another fusing unit.

When the fusing unit is cool enough, a screen shown in FIG. 8A is displayed.

The screen of FIG. 8A shows the guidance for removing the fusing unit: “Open the right-side door to remove screws securing the fusing unit, and then remove the fusing unit” and a caution: “Fusing unit and its surroundings may be hot. Please wait until the temperature goes down enough”.

The managing user follows this guidance to remove the fusing unit; and when the removal of the fusing unit is completed, the managing user presses a “Next” key in the lower right corner of the screen to move to a screen shown in FIG. 8B.

The screen in FIG. 8B shows the guidance for installing another fusing unit: “Install a fusing unit after checking its labels and fasten the screws to secure the fusing unit, and then close the right-side door” and the caution (same as shown in FIG. 8A).

The managing user follows this guidance to install a fusing unit; and when the installation of the fusing unit is completed, the managing user presses a “Next” key in the lower right corner of the screen to move to a screen shown in FIG. 9.

FIG. 9 shows an example of a fusing unit selection screen displayed on the display 171 after the replacement of the fusing unit of the digital multifunction device 1 of FIG. 1.

Immediately after the completion of the replacement to a different type of fusing unit, the fusing unit before the replacement is still selected (still shown on the screen), and thus the managing user selects a type of fusing unit that is newly installed.

In the example in FIG. 9, a fusing unit for an “A3W, A4W/SRA3, SRA4” paper sheet is selected.

After selecting the fusing unit, the managing user presses an “Exit” key.

FIG. 10 shows an example of a screen indicating the currently installed fusing unit that is displayed on the display 171 after the replacement of the fusing unit of the digital multifunction device 1 of FIG. 1.

As shown in FIG. 10, the currently selected (installed) fusing unit is displayed, and fusing units other than the selected fusing unit (i.e., unselected fusing units) and status values for the unselected fusing units in the status section are grayed out.

In this way, it is possible to realize the digital multifunction device 1 that is capable of making preparations for replacement of a fusing unit more appropriately than before.

Preferred embodiments of the present disclosure include combinations of any of the embodiments described above.

The present disclosure may have various modifications in addition to the embodiments described above. Such modifications should not be construed as falling outside the scope of the present disclosure. The present disclosure should include the claims and their equivalents, and all modifications within the scope of the claims.

What is claimed is:

1. An image forming apparatus comprising:
an image former that performs image formation by heating and fusing toner on a recording medium with a removable and replaceable fusing unit;
a fusing unit detector that detects whether the fusing unit is installed;
an operation receiver that receives a command from a user; and
a controller having at least one CPU, the controller controlling the image former, the fusing unit detector, and the operation receiver, wherein
when the operation receiver receives a command to prepare for replacement of the fusing unit, the controller causes the fusing unit detector to detect whether the fusing unit is installed; and when the fusing unit is not installed, the controller determines that the fusing unit is ready to be replaced.

2. The image forming apparatus according to claim 1, wherein
when the operation receiver receives the command to prepare for replacement of the fusing unit, the controller determines whether predetermined replacement preparation completion conditions of the fusing unit are met; and when the replacement preparation completion conditions are met, the controller determines that the fusing unit is ready to be replaced.

3. The image forming apparatus according to claim 2, wherein
when a predetermined time has elapsed since the fusing unit was in a predetermined temperature control stopped state, the controller determines that the replacement preparation completion conditions are met.

4. The image forming apparatus according to claim 1, further comprising a fusing unit cooler that cools the fusing unit, wherein
when the operation receiver receives the command to prepare for replacement of the fusing unit, the controller causes the fusing unit detector to detect whether the fusing unit is installed; and when the fusing unit is installed, and the predetermined replacement preparation completion conditions of the fusing unit are not met, the controller causes the fusing unit cooler to start cooling the fusing unit.

5. The image forming apparatus according to claim 4, further comprising a temperature measuring unit that measures temperature of the fusing unit, wherein
after the controller causes the fusing unit cooler to start cooling the fusing unit, and when the temperature measuring unit measures that the fusing unit has cooled to a predetermined temperature, the controller determines that the fusing unit is ready to be replaced.
